(19) United States
(12) Patent Application Publication
(10) Pub. No.: US 2003/0227138 A1
(43) Pub. Date: Dec. 11, 2003

(54) Convoluted boot cap with press fit

(76) Inventors: Joachim Schneider, Mombris (DE); Bernd Sauerwein, Hanau (DE)

Correspondence Address: Robert P. Renke, Suite 250, 28333 Telegraph Road, Southfield, MI, 48034, US

(21) Appl. No.: 10/439,119

(22) Filed: May 15, 2003

(30) Foreign Application Priority Data
May 15, 2002 (DE) 102 21 438.7

(51) Int. Cl. F16J 15/38

(52) U.S. Cl. 277/391

(57) ABSTRACT

A plate metal connecting cap (11) having an annular sleeve (12) for fixing a convoluted boot or rolling boot to the outer joint part of a constant velocity universal joint, wherein the outer joint part forms a circular-cylindrical seat face with a given diameter for the annular sleeve, wherein the sleeve (12) comprises face portions whose inner diameter is greater than the given diameter of the seat face of the outer joint part and wherein the sleeve (12) includes inner formations whose inscribed inner diameter is smaller than the given diameter of the seat face of the outer joint part.

### TECHNICAL FIELD

The invention relates to a connecting cap having an annular sleeve for fixing a convoluted boot or rolling boot to the outer joint part of a constant velocity universal joint, wherein the outer joint part forms a circular-cylindrical seat face with a given diameter for the annular sleeve.

### BACKGROUND OF THE INVENTION

In some constant velocity joint assemblies, after the outer joint part, a ball hub, torque transmitting balls and a ball cage have been fully assembled, a profiled shaft having profiled toothing is inserted into the ball hub and secured axially. A fixing cap secured to a convoluted boot or rolling boot at one end is then slid on to the outer joint part. The fixing cap should be fixed on the outer joint part in a self-holding way for the purpose of reliably sealing the grease-containing joint while being transported to the predetermined assembly point. During the final assembly of the joint and of the driveshaft containing the joint, the fixing cap provided with bolt holes, together with the outer joint part, is threaded on to a counter flange or the like. The fixing cap is thus axially secured to and sealed relative to the outer joint part by threaded fasteners which tension the annular face of the cap to the end face of the outer joint part.

To date, outer joint part end caps of the foregoing type have been produced so as to comprise an annular-cylindrical sleeve which, by means of a press fit, is slid on to the outer joint part. It has been found that thereby previously properly assembled constant velocity joints meeting easy running requirements have been disadvantageously changed with respect to their operating properties. More particularly, the plunging and articulation forces of the constant velocity joints had been increased after the caps had been mounted, from which it would be concluded that the clearances in the joint, more particularly the clearance of the balls in the ball tracks, had become too small. Under operational conditions, this leads to an increase in friction and thus to increased temperatures and to failure. It has to be assumed that the cap slid on to achieve a press fit changes the shape of the outer joint part, more particularly the shape of the ball tracks. Caps of this type are known from U.S. Pat. No. 6,443,461.

### SUMMARY OF THE INVENTION

The present invention provides a connecting cap for an outer joint part of a constant velocity joint which remains fixed during transit and handling and which does not lead to deformation at the outer joint part.

According to a first solution, the annular-cylindrical sleeve of the cap comprises inner cylindrical face portions which are centered on a longitudinal axis. The inner diameter of the inner cylindrical face portions is greater than the given diameter of the seat face of the outer joint part. Also, in the sleeve, relative to the inner cylindrical face portions, there are provided inwardly formed rib-like inner formations whose inscribed inner diameter is smaller than the given diameter of the seat face of the outer joint part. For purposes of this application, an inscribed inner diameter is a circular diameter which tangentially rests against the inner formation and which is positioned concentrically relative to the inner face portions of the sleeve. The inner face portions of the sleeve can comprise a clearance fit or transition fit relative to the diameter of the cylindrical seat face on the outer joint part. This measure ensures that the sleeve itself does not have to be widened as a whole when being slid on to the outer joint part; only the inner formations are elastically deformed, so that, overall, the deformation forces are low. Nevertheless, the connecting cap continues to be mounted in such a way that it remains connected to the assembly during transit and handling.

According to a first embodiment, the inner formations are provided in the form of longitudinal or helical ribs on an inner cylindrical face. The inner circumference of the sleeve is thus greater than the outer circumference of the seat face of the outer joint part. Thus, the required deformation of the sleeve only requires local bending movements in the region of the inner ribs. As a result, there are no high circumferential stresses in the sleeve.

According to a second embodiment, the inner formations are provided in the form of at least one circumferential rib in an inner cylindrical face. The rib regions are stretched in the circumferential direction during installation. However, the forces required for this purpose are very much lower than in those cases where the entire sleeve has to be elastically stretched in the circumferential direction.

According to a further embodiment which can be used in connection with a previous embodiment, the inner formation is provided in the form of a circular step whose diameter is smaller than that of the seat face, and which adjoins a cylindrical inner face with a greater diameter than the circular step. The deformation forces required when sliding the sleeve on to the seat face are once again slightly higher, which means that the firm fit is improved accordingly. This embodiment can be used for outer joint parts with a greater strength, such as those with a base formed on one side.

According to a further solution, the sleeve comprises a polygon-like cross-sectional shape which comprises circumferential face portions whose inner diameter is greater than the given diameter of the seat face of the outer joint part, and which comprises intermediate circumferential face portions whose inner diameter is smaller than the given diameter of the seat face of the outer joint part. The inner circumference of the sleeve is greater than or equal to the outer circumference of the seat face. According to yet a further solution, the sleeve comprises an oval cross-sectional shape which comprises circumferential face portions whose inner diameter is greater than the given diameter of the seat face of the outer joint part, and which comprises intermediate circumferential face portions whose inner diameter is smaller than the given diameter of the seat face of the outer joint part. The inner circumference of the sleeve is greater than the cylindrical circumference of the seat face. These two embodiments provide examples which require very low deformation forces when sliding the sleeve on to the outer joint part. During the sliding-on movement, the polygonal or ovalised cross-sectional shape, as a result of bending deformation, is adapted to the cylindrical shape of the outer joint part without substantial tensile stresses occurring in the circumferential direction.

Other advantages and features of the invention will also become apparent upon reading the following detailed description and appended claims, and upon reference to the accompanying drawings.

### BRIEF DESCRIPTION OF THE DRAWINGS

For a more complete understanding of this invention, reference should now be made to the embodiments illustrated in greater detail in the accompanying drawings and described below by way of examples of the invention.

In the drawings:

FIG. 1 shows a longitudinal sectional view of a convoluted boot connecting cap in accordance with the present invention in an exemplary constant velocity joint assembly.

FIG. 2 shows a connecting cap in a first embodiment:

A) in an axial view, and

B) in a longitudinal section.

FIG. 3 shows a connecting cap in a second embodiment:

A) in an axial view, and

B) in a longitudinal section.

FIG. 4 shows a connecting cap in a third embodiment:

A) in an axial view, and

B) in a longitudinal section.

FIG. 5 shows a connecting cap in a fourth embodiment:

A) in an axial view, and

B) in a longitudinal section.

FIG. 6 shows a connecting cap in a fifth embodiment:

A) in an axial view, and

B) in a longitudinal section.

FIG. 7 shows a connecting cap in a sixth embodiment:

A) in an axial view, and

B) in a longitudinal section.

FIG. 8 shows a connecting cap in a seventh embodiment:

A) in an axial view, and

B) in a longitudinal section.

FIG. 9 shows a connecting cap in an eighth embodiment:

A) in an axial view, and

B) in a longitudinal section.

FIG. 10 shows a connecting cap in a ninth embodiment:

A) in an axial view, and

B) in a longitudinal section.

FIG. 11 shows a connecting cap in a tenth embodiment:

A) in an axial view, and

B) in a longitudinal section.

FIG. 12 shows a connecting cap in an eleventh embodiment in an axial view.

FIG. 13 shows a connecting cap in a twelfth embodiment in an axial view.

### DETAILED DESCRIPTION OF THE INVENTION

In the following description, various components and features are described for several embodiments. These specific features and components are included as examples and are not meant to be limiting.

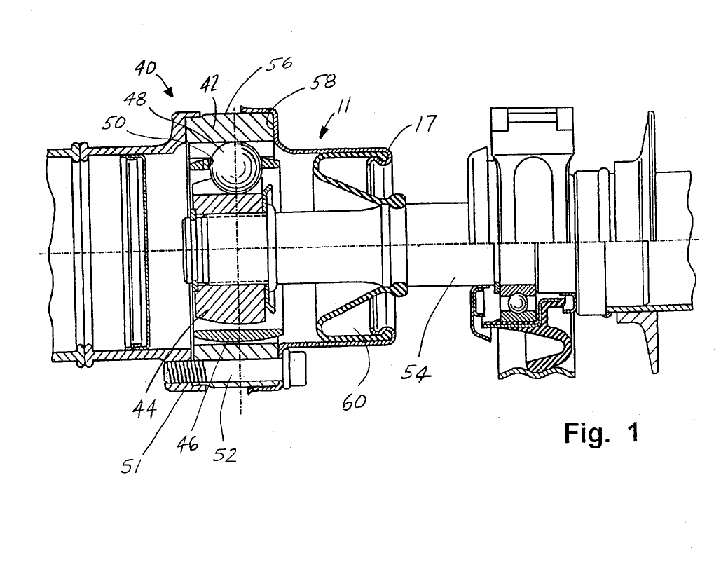

Referring now to the drawings wherein like reference numerals are used to identify similar components in the various views, FIG. 1 illustrates a longitudinal sectional view of a convoluted boot connecting cap 11 in accordance with the present invention in an exemplary environment where it may be advantageously employed.

In this example, the connecting cap 11 is shown with reference to an axially plungeable cross-groove (VL) constant velocity joint 40. The constant velocity joint 40 comprises an outer joint part 42, an inner joint part 44, a ball cage 46 and torque transmitting balls 48 each held in a cage window 50. In the joint shown, during relative displacement movements between the outer joint part 42 and inner joint part 44, the cage 46 with the balls 48 is guided on to half the displacement path relative to each of the joint components 42, 44. The outer joint part 42 at one end is connected to annular flange 51 by way of threaded fasteners 52. The inner joint part 44 receives a connecting shaft 54 and is axially secured thereto by known mechanism. A connecting cap 11 in accordance with the present invention is held on the outer cylindrical surface or seat face 56 of the outer joint part 42 and subsequently fixed to the end face 58 of the outer joint part 42 by the threaded fasteners 52. The inner beading 17 of the cap 11 secures one end of a rolling boot 60 which seals the cap 11 relative to the shaft 54.

Of course, the connecting cap 11 in accordance with the present invention can also be used in other constant velocity joint assemblies and is not limited to the environment shown. For example, other types of constant velocity joints may be used in connection with the inventive cap 11 including joints having outer joint parts with a formed-on base. Indeed, the present cap 11 can be used in connection with any device having a cylindrical outer surface or seat face 56 and corresponding annular end face 58.

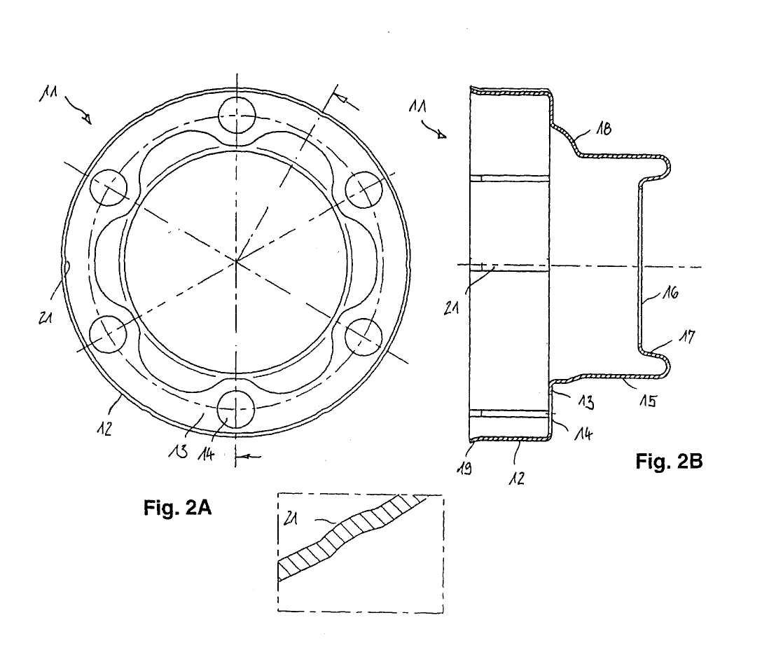

Various embodiments for the cap 11 will now be described in detail with reference to FIGS. 2-13. With respect to features which they have in common, FIGS. 2-13 will first be described jointly. In each axial view and in a section along the sectional line according to illustration A) and in the longitudinal section in illustration B), there is shown an inventive fixing cap 11 which comprises an approximately annular-cylindrical sleeve portion 12 to be slid on to an outer joint part, a radial bolting-on face 13 with bolt holes 14 as well as a carrier projection 15. The carrier projection 15 comprises a through-aperture 16 for a driveshaft and inner beading 17 for securing a rolling boot. In the projection 15, there are provided vaulted portions 18 which serve as spherical stops for balls of the constant velocity joint. In its inside, in the region of the bolt holes 14, the bolting-on face 13 is widened and delimited by a blossom-shaped line. At the sleeve end opposite the bolting-on face 13, there is provided an introduction cone 19. The cap 11 can advantageously be made of plate metal which can be deep-drawn or rolled or stamped to the desired shape. The inner formations described below can be stamped or rolled into the metal cap. The cap can have a uniform thickness, or it can be varied in the region of the securing feature.

In FIG. 2, the sleeve 12, between each two bolt holes 14, comprises an axially extending rib 21. With six bolt holes, there are provided six such ribs arranged so as to be circumferentially distributed on the inside of the sleeve. The enlarged detail shows the circular-arch-shaped cross-section of the rib 21 which is produced by stamping in a rib from the outside. The ribs 21 extend along the entire axial length of the sleeve 12.

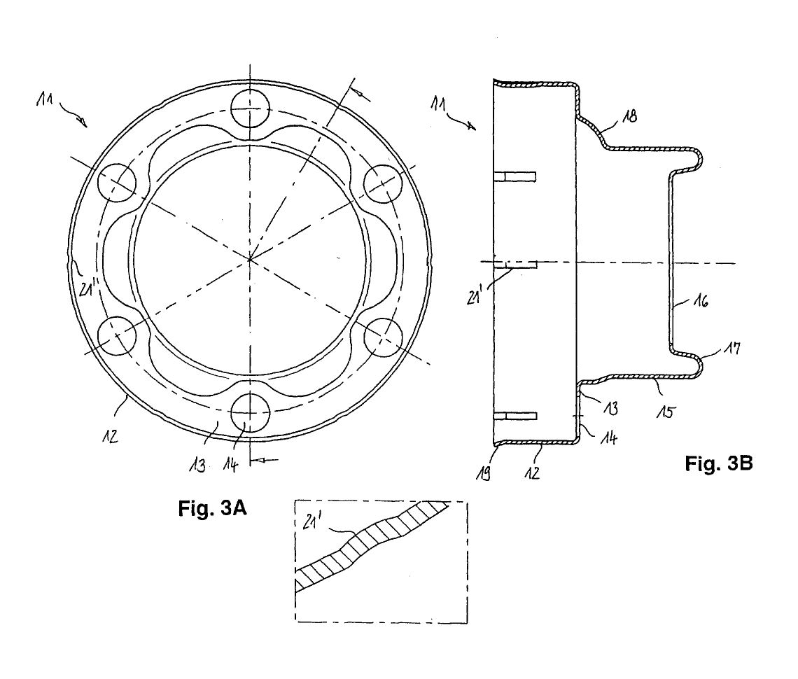

FIG. 3 deviates from FIG. 2 in that there are provided six circumferentially distributed ribs 21′ which extend from the introduction cone 19 approximately as far as one half of the sleeve 12. Otherwise, this embodiment corresponds to that shown in FIG. 2.

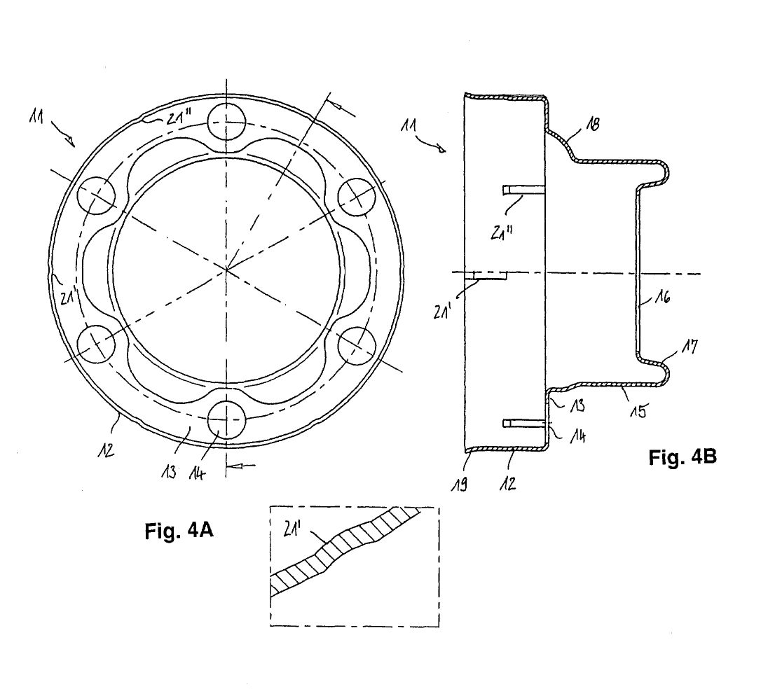

In FIG. 4, the sleeve 12 comprises six circumferentially distributed longitudinal ribs of which first longitudinal ribs 21′ extend from the introducing cone 19 approximately as far as one half of the sleeve 12, with second longitudinal ribs 21″ extending from the bolting-on face 13 approximately as far as one half of the sleeve 12. Three first longitudinal ribs 21′ and three second longitudinal ribs 21″ alternate circumferentially on the inside of the sleeve 12.

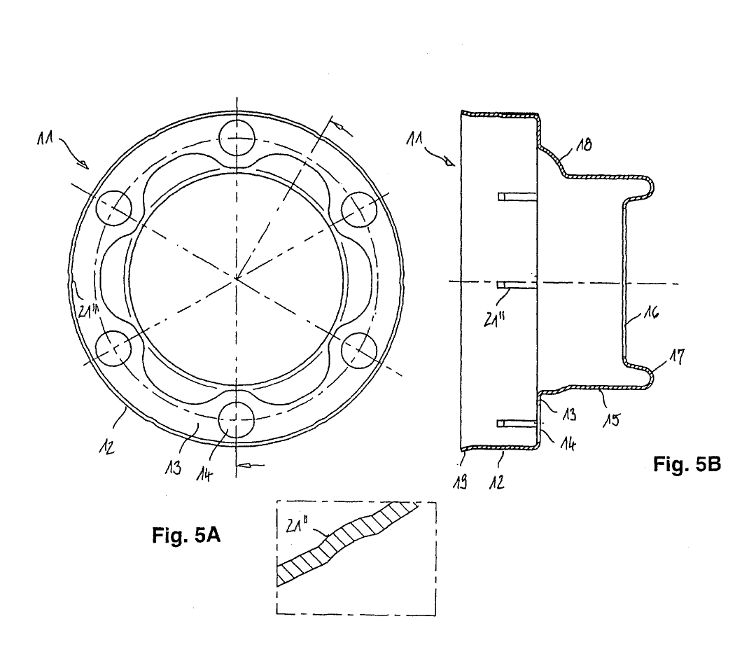

In FIG. 5, the sleeve 12 is provided with circumferentially distributed longitudinal ribs 21″ which all extend from the bolting-on face 13 approximately as far as one half of the sleeve 12.

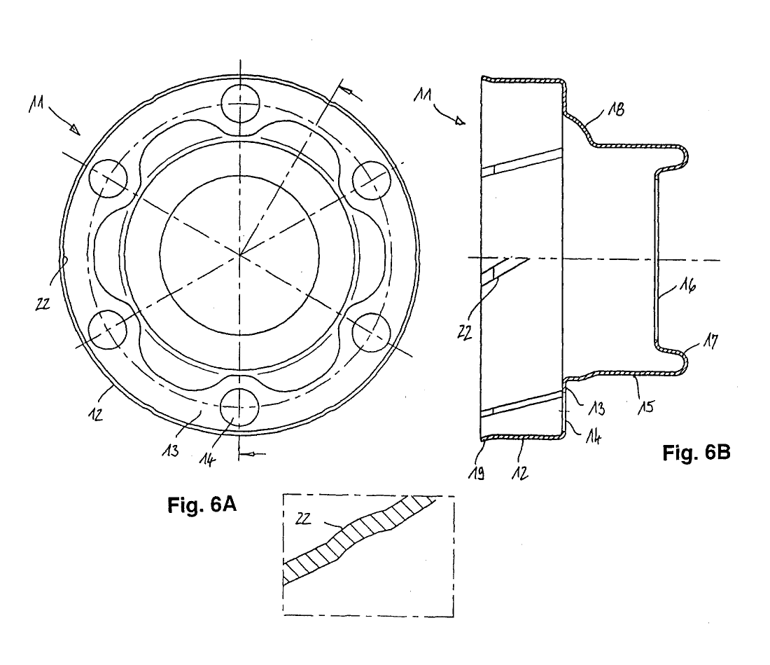

In FIG. 6, the sleeve 12 is provided with inclined ribs 22 which, on the inside of the sleeve 12, extend along the entire length of the introduction cone 19 as far as the bolting-on face 13 and whose angles of inclination have identical pitches relative to the longitudinal axis, but they can also be varied.

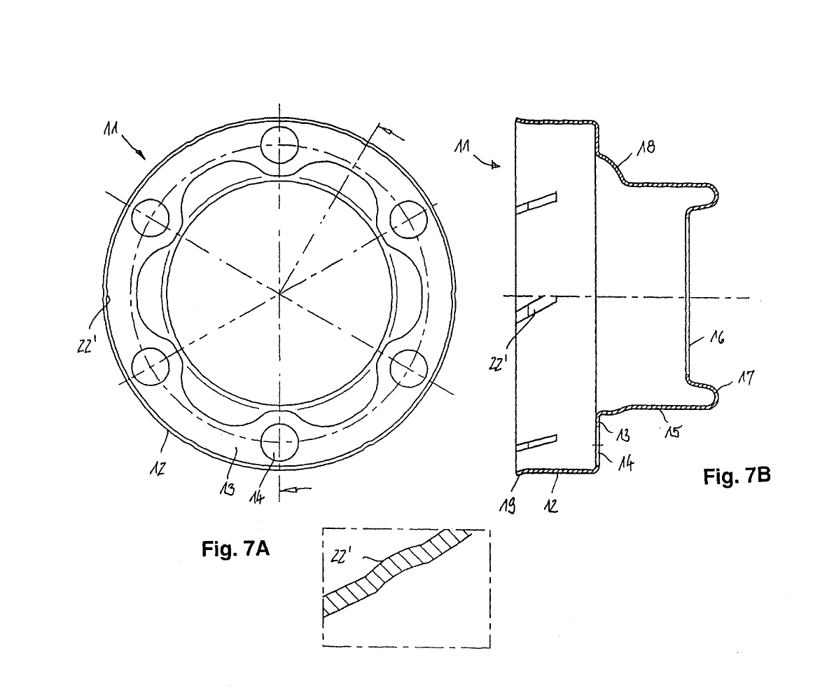

In the sleeve 12 in FIG. 7 there are provided six circumferentially distributed inclined ribs 22′ which extend from the introduction cone 19 approximately as far as one half of the sleeve 12. The angles of inclination have identical pitches relative to the longitudinal axis but they can also be varied.

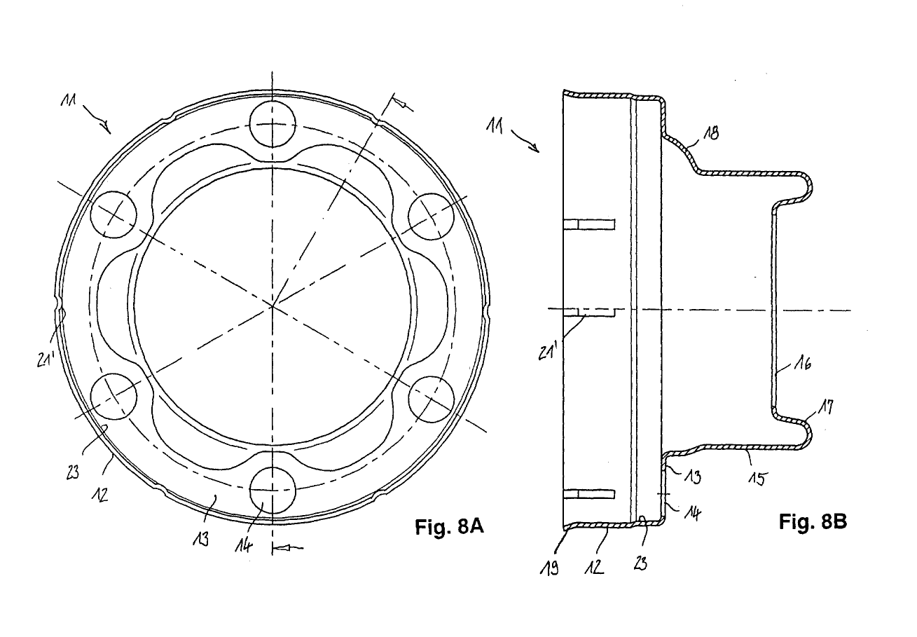

In the sleeve 12 in FIG. 8, there are provided six circumferentially distributed longitudinal ribs 21′ which extend from the introducing cone 19 approximately as far as one half of the sleeve. The sleeve 12 is provided with an inner annular step 23 which starts from the bolting-on face and whose inner diameter is smaller than the given outer diameter of the seat face of the outer joint part.

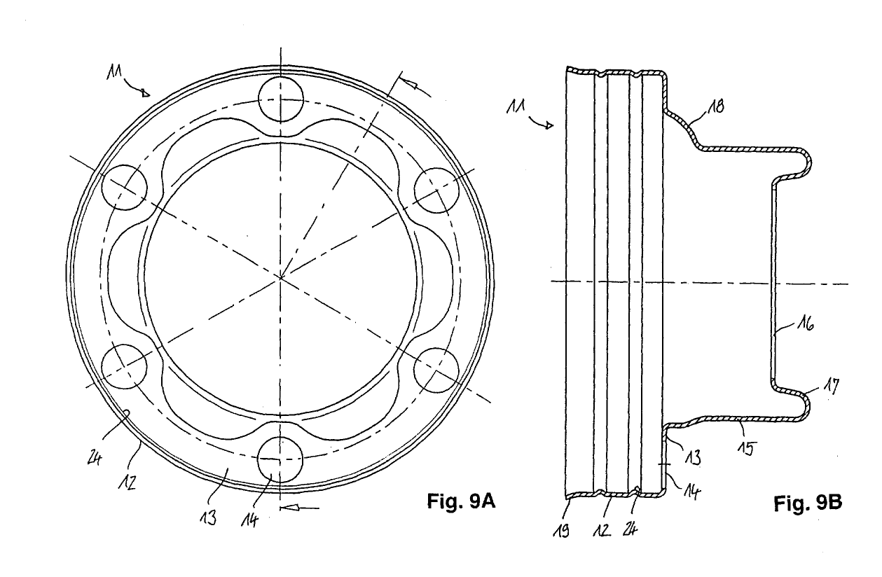

In FIG. 9, the sleeve 12 is provided with two circumferential ribs 24 which are arranged at a distance from one another on the inside of the sleeve and which are positioned approximately at identical distances from the introduction cone 19 and from the bolting-on face 13. The circumferential ribs 24 can be continuous or discontinuous.

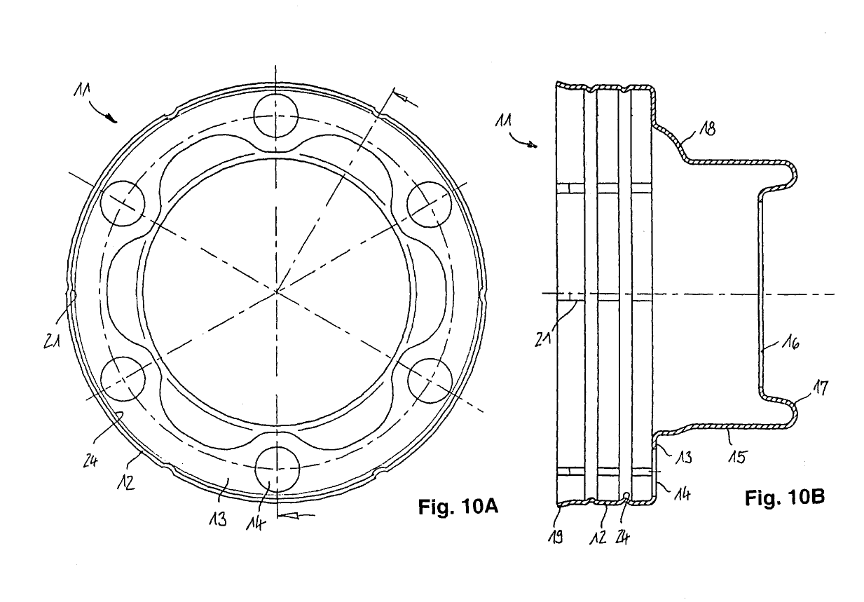

In FIG. 10, the sleeve, in combination, comprises two circumferential ribs 24 arranged in the same way as in FIG. 9, as well as six longitudinal ribs 21 arranged in the same way and in the same design as in FIG. 2.

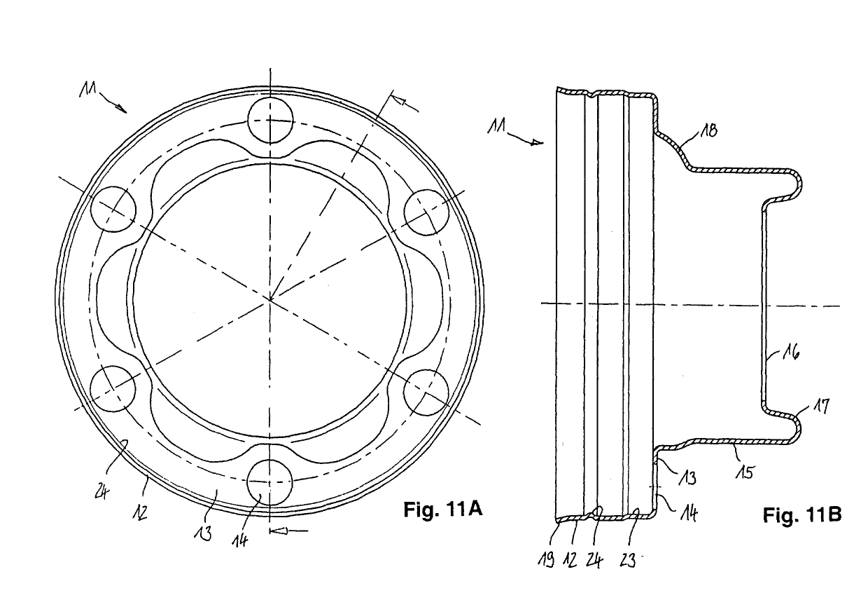

In FIG. 11, the sleeve is provided with a circumferential rib 24 arranged at a shorter distance from the introduction cone 19 and with an inner circular step 23 which starts from the bolting-on face 13 and comprises approximately one third of the length of the sleeve 12.

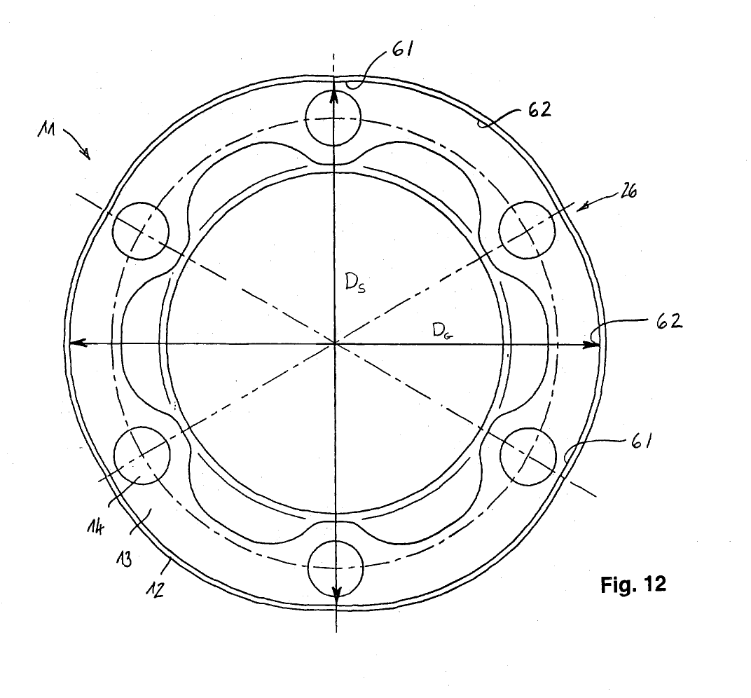

In FIG. 12, the sleeve 12 does not comprise rib-shaped inner formations, but is polygonal in cross section in its entirety, as can be seen in the plan view, having flattened portions 26 in the region of the fixing holes 14. The flattened portions 26 define intermediate circumferential face portions 61 whose inner diameter D_{S} is smaller than the given diameter of the seat face of the outer joint part. The remaining circumferential face portions 62 have a greater diameter DG than the given diameter of the seat face of the outer joint part. The inner circumference of the sleeve, however, can be greater than or equal to the outer circumference of the seat face.

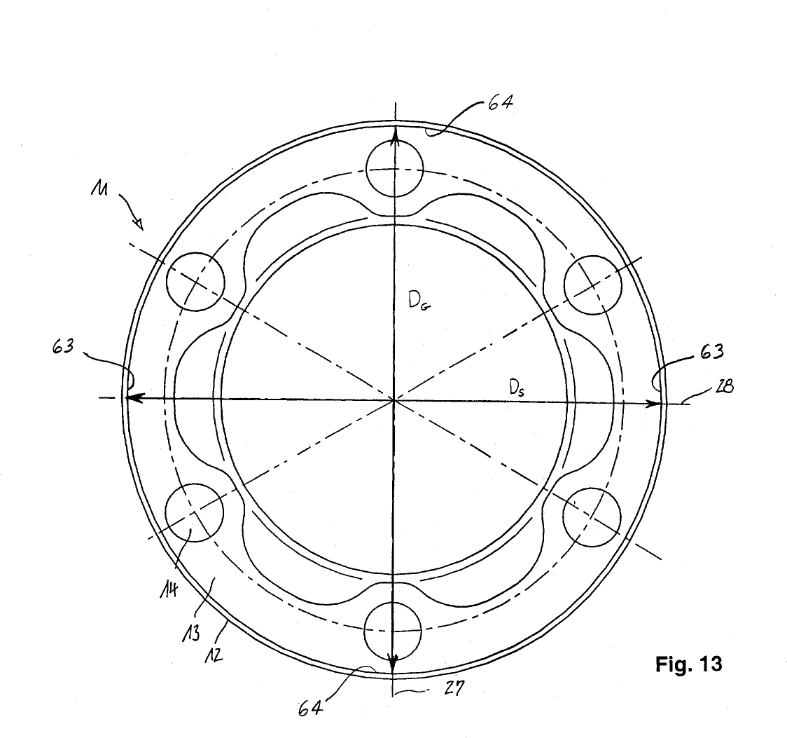

In FIG. 13, the sleeve does not comprise pronounces rib-shaped inner formations, but is ovalised in cross section in its entirety, as can be seen in the plan view, having a longer axis 27 and a shorter axis 28. The shorter axis 28 defines intermediate circumferential face portions. 63 whose inner diameter D_{S} is smaller than the given diameter of the seat face of the outer joint part. The larger axis 27 defines circumferential face portions 64 whose inner diameter D_{G} is greater than the inner diameter of the seat face of the outer joint part. The overall inner circumference of the sleeve, however, can be greater than or equal to the outer circumference of the seat face.

While the invention has been described in connection with several embodiments, it should be understood that the invention is not limited to those embodiments. For example, all of the securing elements described above—the longitudinal ribs 21, the inclined ribs 22, the circumferential ribs 24, the circular step 23, or the cross-sectional shape of the sleeve 12—can be used in various combinations, and all such combinations are contemplated by the present invention. Thus, the invention covers all alternatives, modifications, and equivalents as may be included in the spirit and scope of the appended claims.

What is claimed is:

1. A connecting cap (11) comprising an annular sleeve (12) for fixing a convoluted boot or rolling boot to an outer joint part of a constant velocity universal joint, wherein the outer joint part forms a circular-cylindrical seat face (56) with a given diameter for the annular sleeve, the sleeve (12) comprising inner cylindrical face portions which are centered on a longitudinal axis and whose inner diameter is greater than the given diameter of the seat face of the outer joint part, and wherein the sleeve (12), relative to the inner cylindrical face portions, includes inwardly formed, rib-like inner formations whose inscribed inner diameter is smaller than the given diameter of the seat face of the outer joint part.

2. A connecting cap according to claim 1, wherein the inner formations comprise longitudinal or inclined ribs (21, 22) on an inner cylindrical face.

3. A connecting cap according to claim 1, wherein the inner formations comprise at least one circumferential rib (24) on an inner cylindrical face.

4. A connecting cap according to claim 2, wherein the inner formations comprise a circular step (23) which follows a cylindrical inner face with a greater inner diameter than the circular step (23).

5. A connecting cap according to claim 3, wherein the inner formations comprise a circular step (23) which follows a cylindrical inner face with a greater inner diameter than the circular step (23).

6. A connecting cap according to claim 2 comprising at least three longitudinal or inclined ribs (21, 22) distributed across the circumference.

7. A connecting cap according to claim 3 comprising at least three longitudinal or inclined ribs (21, 22) distributed across the circumference.

8. A connecting cap according to claim 4 comprising at least three longitudinal or inclined ribs (21, 22) distributed across the circumference.

9. A connecting cap according to claim 5 comprising at least three longitudinal or inclined ribs (21, 22) distributed across the circumference.

10. A connecting cap according to claim 3 comprising at least two circumferential ribs (24) arranged at an axial distance from one another.

11. A connecting cap according to claim 4 comprising at least two circumferential ribs (24) arranged at an axial distance from one another.

12. A connecting cap (11) comprising an annular sleeve (12) for fixing a convoluted boot or rolling boot on an outer joint part of a constant velocity universal joint, wherein the outer joint part comprises a circular-cylindrical seat face (56) with a given diameter for the annular sleeve, the sleeve (12) comprising a polygon-like cross-sectional shape which comprises circumferential face portions (62) whose inner diameter is greater than the given diameter of the seat face of the outer joint part and which comprises intermediate circumferential face portions (61) whose inner diameter is smaller than the given diameter of the seat face of the outer joint part, wherein the inner circumference of the sleeve is greater than or equal to the outer circumference of the seat face.

13. A connecting cap (11) comprising an annular sleeve (12) for fixing a convoluted boot or rolling boot on an outer joint part of a constant velocity universal joint, wherein the outer joint part comprises a circular cylindrical seat face with a given diameter for the annular sleeve, the sleeve (12) comprising an oval cross-sectional shape which comprises circumferential face portions whose inner diameter is greater than the given diameter of the seat face of the outer joint part and which comprises intermediate circumferential face portions whose inner diameter is smaller than the given diameter of the seat face of the outer joint part, wherein the inner circumference of the sleeve is greater than or equal to the outer circumference of the seat face.

14. A connecting cap according to claim 1 comprising an introduction cone (19) at an axial end of the sleeve (12) positioned opposite the region where the convoluted or rolling boot is fixed.

15. A connecting cap according to claim 12 comprising an introduction cone (19) at an axial end of the sleeve (12) positioned opposite the region where the convoluted or rolling boot is fixed.

16. A connecting cap according to claim 13 comprising an introduction cone (19) at an axial end of the sleeve (12) positioned opposite the region where the convoluted or rolling boot is fixed.

17. A connecting cap according to claim 2, wherein the cap comprises plate metal of a constant thickness and the ribs (21, 22, 24) are formed by grooves stamped into the plate metal.

18. A connecting cap according to claim 3, wherein the cap comprises plate metal of a constant thickness and the ribs (21, 22, 24) are formed by grooves stamped into the plate metal.

19. A connecting cap according to claim 2 wherein the longitudinal or inclined ribs (21, 22) extend across approximately one-half of the axial length of the sleeve (12).

20. A connecting cap according to claim 19 wherein all of the longitudinal or inclined ribs (21, 22) start from an axial end of the sleeve (12).
